(19) United States
(12) Patent Application Publication
(10) Pub. No.: US 2017/0168829 A1
(43) Pub. Date: Jun. 15, 2017

(54) PROCESSOR, COMPUTING SYSTEM COMPRISING THE SAME AND METHOD FOR DRIVING THE PROCESSOR

(71) Applicant: SAMSUNG ELECTRONICS CO., LTD., Suwon-si (KR)

(72) Inventors: Jun Mo PARK, Hwaseong-si (KR); Ju Hwan KIM, Hwaseong-si (KR); Min Seong KIM, Seoul (KR); Yun Ji KIM, Suwon-si (KR); Taek Hyun KIM, Seongnam-si (KR); Kyung Il SUN, Suwon-si (KR); Myeong Bo SHIM, Gumi-si (KR); Dong Hoon YU, Seongnam-si (KR); Hye Yeon CHUNG, Suwon-si (KR); Sung Hyun HONG, Anyang-si (KR)

(73) Assignee: SAMSUNG ELECTRONICS CO., LTD., Suwon-si (KR)

(21) Appl. No.: 15/371,408

(22) Filed: Dec. 7, 2016

(30) Foreign Application Priority Data
Dec. 9, 2015 (KR) 10-2015-0174631

(51) Int. Cl. G06F 9/38; G06F 12/0875; G06F 9/30

(52) U.S. Cl. CPC G06F 9/384; G06F 9/3855; G06F 9/30072; G06F 9/30101; G06F 12/0875; G06F 2212/452

(57) ABSTRACT

A processor includes a first architectural register configured to store first data based on a result of executing an instruction in a first loop, the first architectural register being mapped to one of a plurality of physical registers; and a control unit configured to determine, before execution of the instruction in an n-th loop (n being a natural number greater than 1), at least one of whether the first data stored in the first architectural register is changed and whether a physical register, among the plurality of physical registers, to which the first architectural register is mapped is changed, and, based on a result of determination, execute the instruction in the n-th loop.

### CROSS-REFERENCE TO RELATED APPLICATION

This application claims priority from Korean Patent Application No. 10-2015-0174631, filed on Dec. 9, 2015, in the Korean Intellectual Property Office, the contents of which is incorporated herein in its entirety by reference.

### BACKGROUND

1. Technical Field

Apparatuses and methods consistent with example embodiments relate to a processor, a computing system comprising the processor, and a method for driving the processor.

2. Description of the Related Art

With the development of the portability and performance of an electronic apparatus, various attempts have been made to reduce the power consumption of the electronic apparatus and improve the performance of the electronic apparatus.

In particular, to reduce an execution time of a loop which accounts for the majority of a program execution time in a processor, it is desirable to increase an execution speed (or frequency) of an instruction, such as an instruction to access to a memory, which may take a processing time of relatively many cycles.

Therefore, to reduce the execution time of the entire loop, studies have been conducted to increase an execution frequency of the instruction in addition to introducing high-speed hardware.

### SUMMARY

One or more example embodiments provide a processor capable of omitting execution of an instruction of storing the same value in the same register in a loop.

One or more example embodiments also provide a method for driving a processor capable of omitting the execution of an instruction of storing the same value in the same register in the loop.

According to an aspect of an example embodiment, provided is a processor including: a first architectural register configured to store first data based on a result of executing an instruction in a first loop, the first architectural register being mapped to one of a plurality of physical registers; and a control unit configured to determine, before execution of the instruction in an n-th loop (n being a natural number greater than 1), at least one of whether the first data stored in the first architectural register is changed and whether a physical register, among the plurality of physical registers, to which the first architectural register is mapped is changed, and, based on a result of determination, execute the instruction in the n-th loop.

According to an aspect of an example embodiment, provided is a computing system including a processor, wherein the processor includes: an execution unit configured to execute an instruction; a first architectural register configured to store first data as a result of executing the instruction in a first loop; a rename unit configured to map the first architectural register to one of a plurality of physical registers; a validation check unit configured to set an ignore flag, a value of the ignore flag indicating whether to execute the instruction in an n-th loop (n being a natural number greater than 1); and a dispatch unit configured to determine whether to provide the instruction to the execution unit in the n-th loop according to the value of the ignore flag.

According to an aspect of an example embodiment, provided is a processor including: a plurality of physical registers; and a control unit configured to access at least one of the plurality of physical registers to execute an instruction, wherein the control unit performs: in a first loop, mapping a destination resistor of the instruction to one of the plurality of physical registers and executing the instruction with respect to the destination register; and in a second loop, mapping the destination register of the instruction to the same physical register mapped in the first loop and setting an ignore flag to have a first value, indicating that execution of the instruction is to be skipped in a subsequent loop.

### BRIEF DESCRIPTION OF THE DRAWINGS

The above and/or other aspects will be more apparent by describing certain example embodiments with reference to the accompanying drawings, in which:

FIG. 1 is a block diagram of a processor according to an example embodiment;

FIGS. 2A and 2B are diagrams explaining an operation of the processor of FIG. 1;

FIG. 3 is a block diagram showing a processor according to another example embodiment;

FIG. 4 is a flowchart illustrating an operation of the processor of FIG. 3;

FIGS. 5A, 5B and 6 are diagrams explaining an operation of the processor of FIG. 3;

FIG. 7 is a block diagram of a system-on-chip (SoC) including a processor according to an example embodiment;

FIG. 8 is a block diagram of an electronic system including a processor and an SoC system according to an example embodiment; and

FIGS. 9, 10 and 11 illustrate exemplary semiconductor systems to which processors according to example embodiments can be applied.

### DETAILED DESCRIPTION

Certain example embodiments will now be described more fully with reference to the accompanying drawings. Example embodiments may, however, be embodied in many different forms and should not be construed as being limited to the embodiments set forth herein. Rather, these embodiments are provided so that this disclosure will be thorough and complete and will fully convey the concept of the embodiment to those skilled in the art, and the scope of the disclosure will only be defined by the appended claims. In the drawings, the thickness of layers and regions may be reduced or exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The use of the terms “a” and “an” and “the” and similar referents in the context of describing the embodiment (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings.

The disclosure will be described with reference to perspective views, cross-sectional views, and/or plan views, in which example embodiments are shown. Thus, the profile of an exemplary view may be modified according to manufacturing techniques and/or allowances. That is, example embodiments are not intended to limit the scope but cover all changes and modifications that can be caused due to a change in manufacturing process. Thus, regions shown in the drawings are illustrated in schematic form and the shapes of the regions are presented simply by way of illustration and not as a limitation.

Unless defined otherwise, all technical and scientific terms used herein have the same meaning as commonly understood by one of ordinary skill in the art to which this embodiment belongs. It is noted that the use of any and all examples, or exemplary terms provided herein is intended merely to better illuminate the embodiment and is not a limitation on the scope of the embodiment unless otherwise specified. Further, unless defined otherwise, all terms defined in generally used dictionaries may not be overly interpreted.

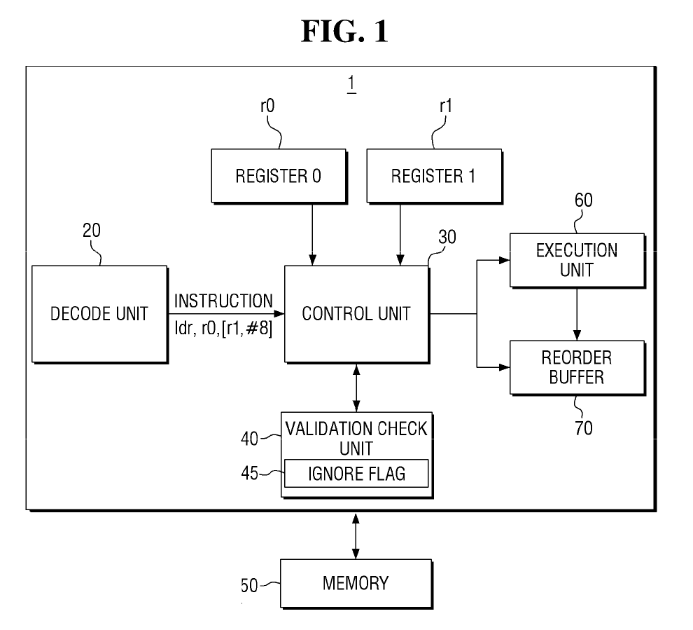

FIG. 1 is a block diagram of a processor according to an example embodiment.

Referring to FIG. 1, a processor 1 according to an example embodiment includes a decode unit 20, a control unit 30, a validation check unit 40, an execution unit 60, a reorder buffer 70, and first and second architectural registers r0 and r1. The processor 1 may be connected to a memory 50.

The decode unit 20 may decode an instruction received from the memory 50 and provide the decoded instruction to the control unit 30.

The instruction may include, for example, an operational code (or opcode) indicating a type of an operation, and an operand that specifies data to be processed or an address at which data is stored.

Accordingly, a result of decoding to be provided from the decode unit 20 to the control unit 30 may include a type of an operation to be performed by the processor 1, data to be processed or a specified address thereof.

By way of example, FIG. 1 shows that the instruction provided from the decode unit 20 instructs the control unit 30 to load, onto a first architectural register r0, data stored at a memory address corresponding to a value obtained by adding 8 to a value stored in the second architectural register r1. In this case, in the operand, the first architectural register r0 which is a destination of the load operation may be defined as a destination register.

The decode unit 20 may divide the instruction in the form of micro-ops (or μops) and provide the divided instructions to the control unit 30.

The control unit 30 may determine whether to execute the instruction in an n-th (e.g., n being a natural number greater than 1) loop according to whether values to be stored in the first and second architectural registers r0 and r1 as a result of executing the instruction in the n-th loop are equal to those of a first loop. The operation of the control unit 30 will be described in detail later.

The validation check unit 40 is connected to the control unit 30, and may indicate whether the control unit 30 has changed the first architectural register r0 and/or whether the data stored in the first architectural register r0 as a result of executing the instruction has been changed.

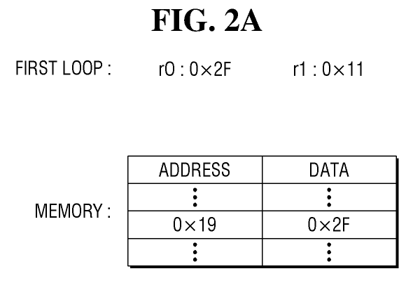

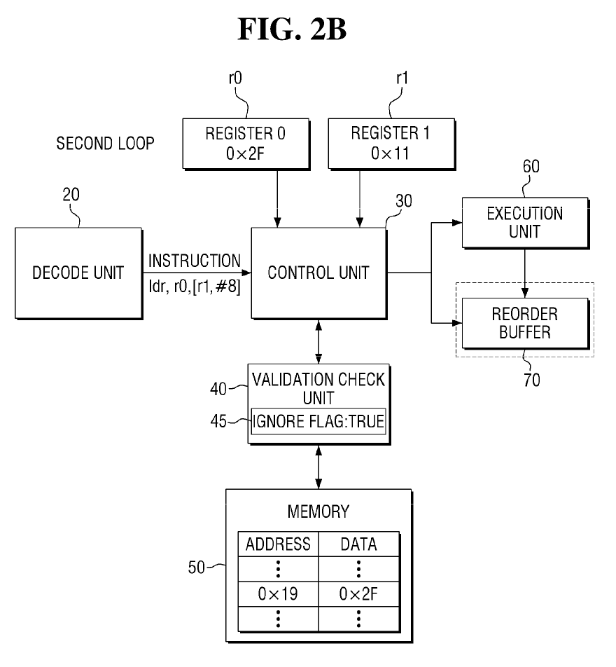

Therefore, the control unit 30 may determine whether to execute the instruction in the n-th loop by checking an ignore flag 45 (refer to FIG. 2B) generated by the validation check unit 40.

The first and second architectural registers r0 and r1 may store the execution result of the instruction executed by the processor 1. The first and second architectural registers r0 and r1 may include 32-bit or 64-bit registers, but example embodiments are not limited thereto.

In the processor 1 according to an example embodiment, the first and second architectural registers r0 and r1 store integer type data, but this is merely an example. For example, the first and second architectural registers r0 and r1 may store floating point data.

In some example embodiments, the architectural registers included in the processor 1 are not limited to the first and second architectural registers r0 and r1. For example, any architectural register and any number of architectural registers may be included in the processor 1 depending on a design intent.

The execution unit 60 may receive the instruction from the control unit 30 and execute the received instruction. The execution unit 60 may include, for example, an arithmetic logic unit (ALU), a load/store unit, or a floating point unit (FPU), but example embodiments are not limited thereto. For example, any part which may execute the instruction decoded by the decode unit 20 may be included in the execution unit 60.

The execution unit 60 may execute the instructions provided from the control unit 30 in a sequential order or a non-sequential order. The execution unit 60 may write the completion of the execution of the instruction to the reorder buffer 70.

In an example embodiment, the reorder buffer 70 may be accessed by the control unit 30 and/or by the execution unit 60. Accordingly, without executing an instruction, the completion of the execution of the instruction may be written to the reorder buffer 70.

The memory 50 may store the instruction to be provided to the decode unit 20 and the data associated with execution of the instruction. The memory 50 may be connected to the processor 1 via a plurality of ports.

The memory 50 may have a cache architecture. That is, the memory 50 may include, for example, a level 1 (L1) cache memory connected to the processor.

Although it is described above that the memory 50 is positioned outside of the processor 1 and connected to the processor 1, example embodiments are not limited thereto and the memory 50 may be included in the processor 1.

FIGS. 2A and 2B are diagrams explaining an operation of the processor of FIG. 1.

By way of example, FIG. 2A illustrates data stored in the first and second architectural registers r0 and r1 as a result of executing the instruction in the first loop, an address of the memory 50, and the data stored at a corresponding address.

As shown in FIG. 2A, a value “0x11” is stored in the second architectural register r1. Thus, a memory address “0x19” corresponding to the value obtained by adding 8 to the value “0x11” stored in the second architectural register r1 is referred to and data “0x2F” stored at the corresponding address “0x19” of the memory is loaded and stored in the first architectural register r0 that is a destination register.

Therefore, as a result of the execution of the instruction in the first loop, “0x2F” and “0x11” are stored in the first and second architectural registers r0 and r1, respectively.

FIG. 2B illustrates an operation of determining whether the control unit 30 executes the instructions with respect to the memory 50 and the first and second architectural registers r0 and r1 in the n-th loop.

In the n-th loop, before executing the instruction of “ldr, r0, [r1, #8],” the first architectural register r0 and the second architectural register r1 store data of “0x2F” and “0x11,” respectively. It is assumed that the same values as those stored in the first and second architectural registers r0 and r1 in the first loop described with reference to FIG. 2A are stored.

Further, because the data stored at the address “0x19” of the memory is “0x2F”, it can be determined that the value stored at the corresponding address of the memory 50 in the first loop has not changed.

Accordingly, the control unit 30 may set the value of the ignore flag 45 included in the validation check unit 40 to “TRUE”.

Since the value of the ignore flag 45 is set to “TRUE”, the control unit 30 may determine that the values of the data stored in the first and second architectural registers r0 and r1 and the data stored at the memory address indicated by the value stored in the second architectural register r1 are equal to those of the first loop. Therefore, the control unit 30 may provide the completion of the execution of the instruction to the reorder buffer 70 without delivering the instruction to the execution unit 60.

Thus, the execution result of the instruction in the first loop may be the same as that of the data to be stored in the destination register according to the execution result of the instruction in the n-th loop. In this case, when the instruction is executed in the n-th loop although the same result is expected, the execution time of the program may be increased.

The processor according to an example embodiment may transmit, when it is expected that the same value is to be stored in the register as a result of executing the instruction, the completion of the execution of the instruction to the reorder buffer 70 instead of executing the instruction by transmitting the instruction to the execution unit 60.

Therefore, the processor 1 according to an example embodiment may reduce the processing time of a redundant instruction by writing whether the execution has been completed to the reorder buffer 70 without executing the redundant instruction in the loop.

Further, since the redundant instruction is not executed by the execution unit 60, the driving power consumed by the execution unit 60 may be reduced.

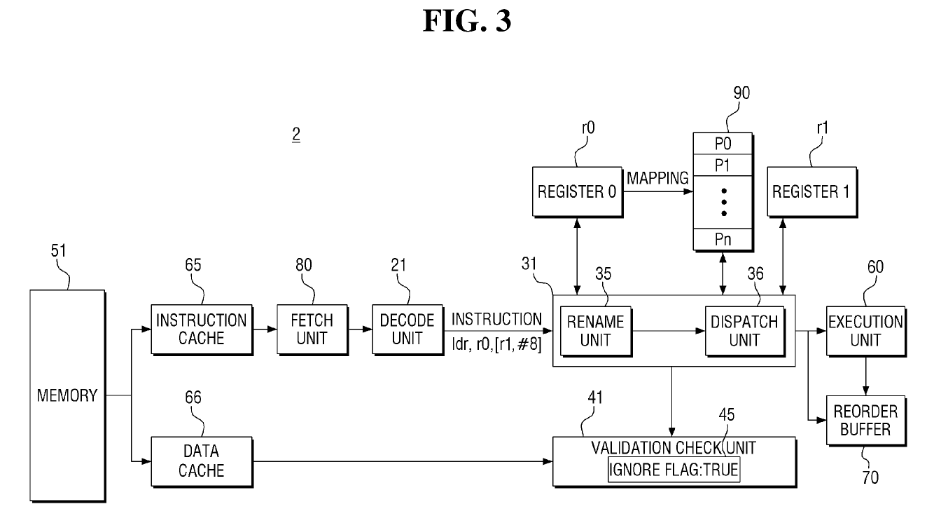

FIG. 3 is a block diagram showing a processor 2 according to another example embodiment. A repetitive description of components and/or operation that is the same or similar to those described above will be omitted.

Referring to FIG. 3, the processor 2 may include an instruction cache 65 and a data cache 66, which may be provided separately. The instruction cache 65 may receive an instruction stream from a memory 51 and provide the instruction stream to a fetch unit 80. The data cache 66 may be provided between the processor 2 and the memory 51 to reduce a delay caused by access of the processor 2 to the memory 51.

Each of the instruction cache 65 and the data cache 66 may be a level 1 (L1) cache memory.

The fetch unit 80 may receive an instruction by accessing the instruction cache 65 that stores the instruction to be provided in the next cycle. Further, the fetch unit 80 may provide the received instruction to a decode unit 21.

The fetch unit 80 may perform a pre-fetch to read the next instruction before the instruction provided from the decode unit 21 has been completely executed by the execution unit 60.

A control unit 31 of the processor 2 according to an example embodiment of FIG. 3 may include a rename unit 35 and a dispatch unit 36.

The rename unit 35 may map the first architectural register r0 to any one physical register of a physical register group 90 including a plurality of physical registers P0, P1, . . . Pn.

An instruction set architecture of the processor 2 according to an example embodiment may include a limited number of architectural registers. Thus, a write-after-write (WAW) and/or write-after-read) dependency problem may occur. The rename unit 35 may solve the dependency problem by mapping the first and second architectural registers r0 and r1 expressed by the same operand in different instructions to any one of the physical registers P0 to Pn.

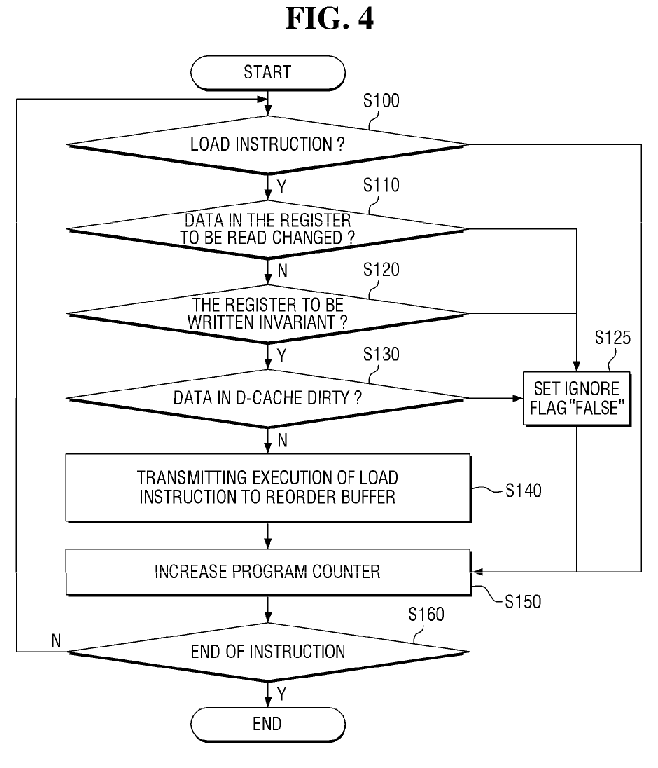

FIG. 4 is a flowchart explaining an operation method of the processor of FIG. 3. Similarly to the above-described example embodiments, in the operation method of the processor described with reference to FIG. 4, a case where the processor 2 executes the instruction of “ldr r0, [r1, #8]” in the first loop and executes the same instruction again in the n-th loop is illustrated as an example.

Referring to FIG. 4, the decode unit 21 determines whether the instruction is a load instruction while decoding the instruction provided from the fetch unit 80 (S100). When the provided instruction is not a load instruction, the instruction may be delivered to the execution unit 60 to be executed normally.

When the provided instruction is a load instruction, it is determined whether the value stored in the second architectural register r1, included in the operand of the instruction, has been changed from the value stored in the first loop (S110).

According to the load instruction illustrated in an example embodiment, the value stored in the second architectural register r1 may indicate an address of the memory where the data to be loaded is present. Therefore, when the data stored in the second architectural register r1 has been changed, the address of the memory to be referred to has also been changed. In this case, the load instruction may not be considered as a redundant operation.

When the data stored in the second architectural register r1 has been changed, a validation check unit 41 of the processor 2 may set the ignore flag to “FALSE” (S125). When the control unit 31 checks the ignore flag that is set to “FALSE”, the instruction is delivered to the execution unit 60 to be executed normally.

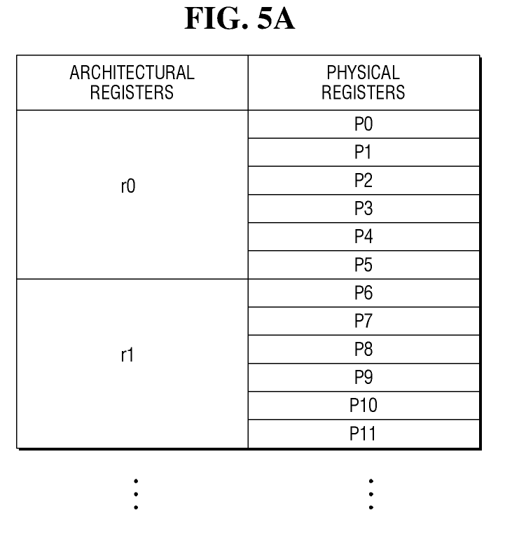

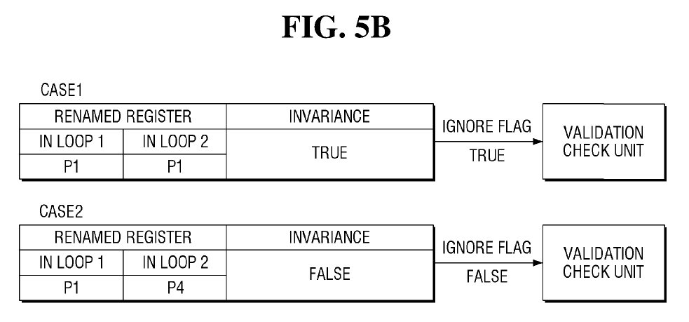

When the value of the register to be read is the same as that of the previous loop, it is determined whether the register where the data is to be written is invariant compared to the previous loop (S120), which will be described in more detail with reference to FIGS. 5A and 5B.

FIG. 5A illustrates an exemplary mapping table in which the first and second architectural registers r0 and r1 is mapped to a corresponding physical register among physical registers P0 to P11. As illustrated in FIG. 5A, the first architectural register r0 may be mapped to any one of the physical registers P0 to P5.

That is, the rename unit 35 may map the architectural register to the physical registers to solve the WAW dependency and/or WAR dependency as described above. The rename unit 35 may perform the mapping of the architectural registers r0 and r1 based on the table illustrated in FIG. 5A.

According to the design and architectural limitations of the processor 2, the number of the physical registers which may be included in the processor 2 may be limited. Thus, the number of the physical registers to which one architectural register may be mapped may also be limited. In this case, six physical registers P0 to P5 may be mapped to one architectural register. However, this is only an example and example embodiments are not limited thereto.

Referring to FIG. 5B, in an example case (or CASE 1), the first architectural register r0 is mapped to the physical register P1 in the first loop and the first architectural register r0 is also mapped to the physical register P1 in a second loop. As a result, when the same instruction as the instruction which has been performed on the first architectural register r0 in the first loop is performed on the first architectural register r0 in the second loop, the value of the physical register P1 to which the first architectural register r0 has been mapped may be maintained to be invariant.

In this case, the control unit 31 may indicate that the execution of the instruction may be ignored by setting the ignore flag 45 to “TRUE”.

On the other hand, another example case (or CASE 2) of FIG. 5B represents a case where the physical registers to which the first architectural register r0 is mapped are different in the first loop and the second loop. When the number of physical registers is not sufficient while the processor 2 performs the instruction, the architectural registers to be subjected to the same instruction may be mapped to different physical registers and fail to solve the dependency problem.

In this case, the instruction is executed for the same physical register. However, since the instruction execution results in the first loop and the second loop are to be written to different physical registers, the execution of the instruction in the second loop may not be ignored. Thus, the control unit 31 (or the validation check unit 41) sets the ignore flag 45 to “FALSE”.

Referring again to FIG. 4, it is determined whether the first data stored in the data cache 66 has been changed, i.e., whether the first data is in a dirty state (S130).

According to the load instruction described as an example in an example embodiment, the data may be read from the memory 51 by referring to the value of the address of the second architectural register r1 as a result of the execution of the first loop. In this case, the data stored in the memory 51 may be stored in the data cache 66.

As a result of executing different instructions in the first loop and the second loop, the data stored in the memory 51 may be updated and the data stored in the memory 51 may be different from the data stored in the data cache 66. In this case, to update the data stored in the data cache 66 to be equal to the data stored in the memory 51, the load instruction may not be ignored. Therefore, by setting the ignore flag to “FALSE” (S125), the instruction is executed. The data cache 66 may change the ignore flag 45 by providing whether the cache data is dirty to the validation check unit 41.

According to a determination result of the above-described condition, when the ignore flag is maintained to be “TRUE”, the load instruction may be transmitted to the reorder buffer 70 and not to the execution unit 60 (S140), and it may be written that the execution of the load instruction has been completed. Thus, by preventing the execution of the redundant instruction, it is possible to reduce the power consumption and improve the execution speed of the processor 2.

After completion of the execution of the instruction or the transmission of the instruction to the reorder buffer, a program counter is increased (S150) and it is determined whether to end the instruction (S160). According to a result of determination in operation S160, the above process may be repeated or ended.

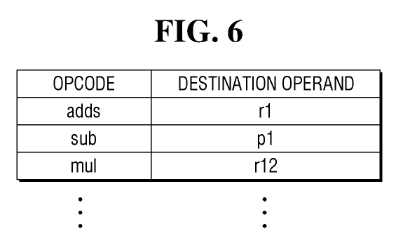

Referring to FIG. 6, the instruction cache 65 may provide the instruction stream shown in the table of FIG. 6 to the control unit 31. In this case, whether the value of the second architectural register r1 has been changed may be determined by checking whether the second architectural register r1 has been included as the destination register in the instruction stream.

That is, when the second architectural register r1 has been used as the destination register of another instruction, the value of the second architectural register r1 in the second loop is likely to be different from that of the first loop. Thus, whether the value of the second architectural register r1 has been changed may be determined by checking whether the second architectural register r1 has been included as the destination register in the provided instruction stream. Further, this operation may be performed simultaneously with the provision of the instruction stream in the first loop without requiring extra execution time after the completion of the first loop.

Although the load instruction has been described as an example in the exemplary embodiments, the exemplary embodiments are not limited thereto. For example, the same operation as described above may be performed when the instruction is a move instruction.

For example, when the instruction is a command such as “fmov r0, #2.000000,” since the data to be referred to is an immediate value rather than the value stored in the register or memory, it is unnecessary to refer to the memory 51 or the second architectural register r1. Therefore, in the above-described process, a determination may be made only as to whether the first architectural register r0 has been mapped to the same physical register.

An instruction such as “vmov r1, f1” to move a value between different registers may be provided. In this case, compared to the previous loop, a determination may be made as to whether the same data has been stored in a register f1 and whether the first architectural register r0 has been mapped to the same physical register.

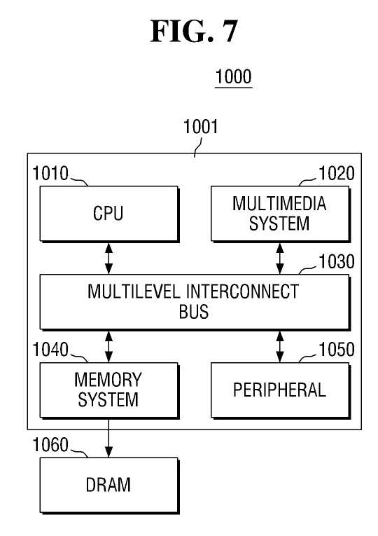

FIG. 7 is a block diagram of a system-on-chip (SoC) including the processor according to an example embodiment.

Referring to FIG. 7, an SoC system 1000 may include an application processor 1001 and a dynamic random access memory (DRAM) 1060.

The application processor 1001 may include a central processing unit (CPU) 1010, a multimedia system 1020, a multi-level connection bus 1030, a memory system 1040, and a peripheral circuit 1050.

The CPU 1010 may perform operations to drive the SoC system 1000. In an example embodiment, the CPU 1010 may be configured to perform operations in a multi-core environment including a plurality of cores.

The multimedia system 1020 may be used to perform various multimedia functions in the SoC system 1000. The multimedia system 1020 may include a three-dimensional (3D) engine module, a video codec, a display system, a camera system, a post-processor and the like.

The multi-level connection bus 1030 may be used for data communication between the CPU 1010, the multimedia system 1020, the memory system 1040 and the peripheral circuit 1050. In an example embodiment, the multi-level connection bus 1030 may have a multi-layer structure. Specifically, as an example of the multi-level connection bus 1030, a multi-layer advanced high-performance bus (AHB), or a multi-layer advanced extensible interface (AXI) may be used, but example embodiments not limited thereto.

The memory system 1040 may provide an environment in which the application processor 1001 is connectable to an external memory (e.g., the DRAM 1060) and operate at high speed. In an example embodiment, the memory system 1040 may include a separate controller (e.g., a DRAM controller) to control the external memory (e.g., the DRAM 1060).

The peripheral circuit 1050 may provide an environment in which the SoC system 1000 is connectable to an external device (e.g., a main board). Accordingly, the peripheral circuit 1050 may include various interfaces that allow the external device connected to the SoC system 1000 to be compatible with the SoC system 1000.

The DRAM 1060 may function as an operating memory with respect to the application processor 1001. In an example embodiment, the DRAM 1060 may be placed outside the application processor 1001 as illustrated in FIG. 7. Specifically, the DRAM 1060 may be packaged with the application processor 1001 in the form of package on package (PoP).

The CPU 1010 of the SoC system 1000 may employ the processor according to the above-described example embodiments.

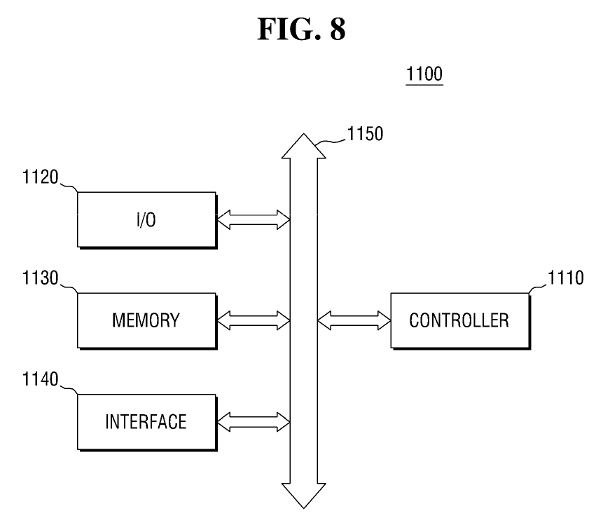

FIG. 8 is a block diagram of an electronic system including the processor and the SoC system according to an example embodiment.

Referring to FIG. 8, an electronic system 1100 according to an example embodiment may include a controller 1110, an input/output (I/O) device 1120, a memory device 1130, an interface 1140 and a bus 1150. The controller 1110, the I/O device 1120, the memory device 1130 and/or the interface 1140 may be connected to one another by the bus 1150. The bus 1150 may serve as a path to receive and/or transmit data.

The controller 1110 may include at least one of, for example, a microprocessor, a digital signal processor, a microcontroller and logic devices capable of performing similar functions to those of a microprocessor, a digital signal processor and a microcontroller. The I/O device 1120 may include a keypad, a keyboard and a display device. The memory device 1130 may store data and/or commands. The interface 1140 may be used to transmit data to and/or receive data through a communication network. The interface 1140 may be a wired and/or wireless interface. For example, the interface 1140 may include an antenna, a wired transceiver, and/or a wireless transceiver.

Although not illustrated in the drawing, the electronic system 1100 may be an operating memory with respect to the controller 1110, and may further include a high-speed DRAM or SRAM.

In addition, the processor according to the above-described example embodiments may be provided in the memory device 1130 or as part of the controller 1110 or the I/O device 1120.

The electronic system 1100 may be applied to, for example, a personal digital assistant (PDA), a portable computer, a web tablet, a wireless phone, a mobile phone, a digital music player, a memory card, or any electronic product capable of transmitting and/or receiving information in a wireless environment.

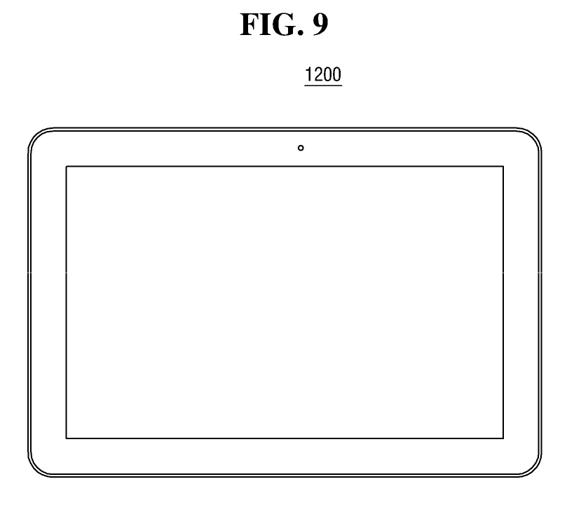

FIGS. 9 to 11 illustrate exemplary semiconductor systems to which processors according to example embodiments can be applied.

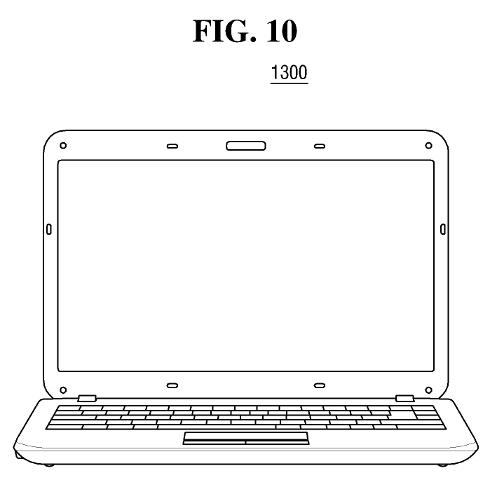

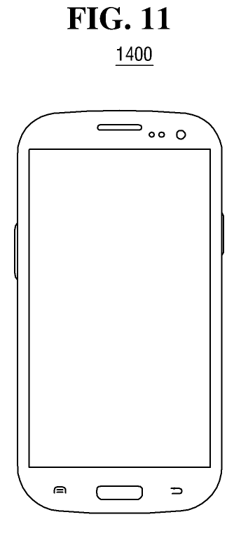

FIG. 9 illustrates a tablet personal computer (PC) 1200, FIG. 10 illustrates a laptop computer 1300, and FIG. 11 illustrates a smart phone 1400. At least one of the processors according to the above-described example embodiments may be used in the tablet PC 1200, the laptop computer 1300, and the smart phone 1400.

It is obvious to those skilled in the art that the semiconductor devices according to example embodiments may also be applied to other integrated circuit devices that are not illustrated.

That is, as examples of the semiconductor system according to example embodiments, the tablet PC 1200, the laptop computer 1300, and the smart phone 1400 have been mentioned, but an example of the semiconductor system according to example embodiments is not limited thereto.

In some example embodiments, the semiconductor system may be implemented as a computer, a ultra mobile personal computer (UMPC), a workstation, a net-book, a personal digital assistant (PDA), a portable computer (PC), a wireless phone, a mobile phone, an e-book, a portable multimedia player (PMP), a portable game console, a navigation device, a black box, a digital camera, a 3-dimensional television, a digital audio recorder, a digital audio player, a digital picture recorder, a digital picture player, a digital video recorder, a digital video player, or the like.

Methods according to exemplary embodiments may be embodied as program commands executable by various computers and may be recorded on a non-transitory computer-readable recording medium. The non-transitory computer-readable recording medium may include program commands, data files, data structures, and the like separately or in combinations. The program commands to be recorded on the non-transitory computer-readable recording medium may be specially designed and configured for example embodiments or may be well-known to and be usable by one of ordinary skill in the art of computer software. Examples of the non-transitory computer-readable recording medium include a magnetic medium such as a hard disk, a floppy disk, or a magnetic tape, an optical medium such as a compact disk-read-only memory (CD-ROM) or a digital versatile disk (DVD), a magneto-optical medium such as an optical disk, and a hardware device specially configured to store and execute program commands such as a ROM, a random-access memory (RAM), or a flash memory. Examples of the program commands are advanced language codes that can be executed by a computer by using an interpreter or the like as well as machine language codes made by a compiler.

At least one of the components, elements, modules or units represented by a block as illustrated in the drawings may be embodied as various numbers of hardware, software and/or firmware structures that execute respective functions described above, according to an exemplary embodiment. For example, at least one of these components, elements or units may use a direct circuit structure, such as a memory, a processor, a logic circuit, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions, and executed by one or more microprocessors or other control apparatuses. Also, at least one of these components, elements or units may further include or implemented by a processor such as a central processing unit (CPU) that performs the respective functions, a microprocessor, or the like. Two or more of these components, elements or units may be combined into one single component, element or unit which performs all operations or functions of the combined two or more components, elements of units. Also, at least part of functions of at least one of these components, elements or units may be performed by another of these components, element or units. Further, although a bus is not illustrated in the above block diagrams, communication between the components, elements or units may be performed through the bus. Functional aspects of the above exemplary embodiments may be implemented in algorithms that execute on one or more processors. Furthermore, the components, elements or units represented by a block or processing steps may employ any number of related art techniques for electronics configuration, signal processing and/or control, data processing and the like.

Although a few embodiments have been shown and described, it would be appreciated by those skilled in the art that changes may be made in example embodiments without departing from the principles and spirit of the disclosure, the scope of which is defined in the claims and their equivalents.

What is claimed is:

1. A processor comprising:
a first architectural register configured to store first data based on a result of executing an instruction in a first loop, the first architectural register being mapped to one of a plurality of physical registers; and
a control unit configured to determine, before execution of the instruction in an n-th loop (n being a natural number greater than 1), at least one of whether the first data stored in the first architectural register is changed and whether a physical register, among the plurality of physical registers, to which the first architectural register is mapped is changed, and, based on a result of determination, execute the instruction in the n-th loop.

2. The processor of claim 1, further comprising:
a second architectural register configured to store second data; and
a memory comprising an area in which the first data is stored,
wherein the instruction causes the processor to access the area by referring to an address value of the memory, the address value being indicated by the second data.

3. The processor of claim 2, wherein the instruction comprises a load instruction to load the first data onto the first architectural register.

4. The processor of claim 2, further comprising an instruction cache configured to provide an instruction stream to the control unit,
wherein the control unit determines whether a destination register of an operand included in the instruction stream comprises the second architectural register.

5. The processor of claim 4, wherein the control unit determines, in the first loop, whether the destination register comprises the second architectural register.

6. The processor of claim 1, wherein the control unit comprises a rename unit that maps the first architectural register to the one of the plurality of physical registers.

7. The processor of claim 6, wherein the rename unit determines whether the first architectural register is mapped to the same physical register in the first loop and the n-th loop.

8. The processor of claim 1, further comprising a validation check unit connected to the control unit,
wherein the validation check unit sets an ignore flag according to at least one of whether the first data is changed and whether the physical register to which the first architectural register is mapped is changed, and
wherein the control unit determines whether to execute the instruction in the n-th loop based on the value of the ignore flag.

9. The processor of claim 8, further comprising a data cache in which the first data is stored, wherein the validation check unit changes the value of the ignore flag in response to the first data stored in the data cache being changed.

10. The processor of claim 1, wherein the instruction comprises a move instruction to move the first data to the first architectural register.

11. The processor of claim 10, further comprising a second architectural register configured to store the first data prior to the execution of the instruction.

12. The processor of claim 1, further comprising an execution unit and a reorder buffer, the execution unit and the reorder buffer connected to the control unit,
wherein the control unit provides the instruction to the execution unit or provides a completion of the execution of the instruction to the reorder buffer in the n-th loop, based on the result of the determination.

13. A computing system comprising a processor,
wherein the processor comprises:
an execution unit configured to execute an instruction;
a first architectural register configured to store first data as a result of executing the instruction in a first loop;
a rename unit configured to map the first architectural register to one of a plurality of physical registers;
a validation check unit configured to set an ignore flag, a value of the ignore flag indicating whether to execute the instruction in an n-th loop (n being a natural number greater than 1); and
a dispatch unit configured to determine whether to provide the instruction to the execution unit in the n-th loop according to the value of the ignore flag.

14. The computing system of claim 13, further comprising a memory,
wherein the first data is loaded from the memory and stored in the first architectural register, and
wherein the ignore flag is set to have a first value in response to the first data stored in the memory being changed.

15. The computing system of claim 13, wherein the validation check unit sets the ignore flag to have a second value in response to the first architectural register being mapped to the same physical register in the first loop and the n-th loop.

16. A processor comprising:
a plurality of physical registers; and
a control unit configured to access at least one of the plurality of physical registers to execute an instruction, wherein the control unit performs:
in a first loop, mapping a destination resistor of the instruction to one of the plurality of physical registers and executing the instruction with respect to the destination register; and
in a second loop, mapping the destination register of the instruction to the same physical register mapped in the first loop and setting an ignore flag to have a first value, indicating that execution of the instruction is to be skipped in a subsequent loop.

17. The processor of claim 16, wherein, when, in the second loop, the destination resister of the instruction is not mappable to the same physical resister mapped in the first loop, the control unit sets the ignore flag to have a second value, indicating that the execution of the instruction is to be performed in the subsequent loop.

18. The processor of claim 16, wherein the instruction is a load instruction to load first data onto the destination register, and the control unit, in response to the first data stored in the destination register being changed in the second loop, sets the ignore flag to have the second value, indicating that the execution of the instruction is to be performed in the subsequent loop.

19. The processor of claim 18, further comprising a data cache in which the first data is stored,
wherein the control unit, in response to the first data stored in the data cache being changed, sets the ignore flag to have the second value.

20. The processor of claim 18, further comprising a memory,
wherein the first data is loaded from the memory and stored in the destination register, and
wherein the control unit sets the ignore flag to have the second value in response to the first data stored in the memory being changed.
